(19) United States
(12) Patent Application Publication
(10) Pub. No.: US 2010/0169427 A1
(43) Pub. Date: Jul. 1, 2010

(54) APPARATUS AND METHOD FOR ADDING ADVANCED CONTENT TO COMPUTERIZED MESSAGES

(75) Inventors: Oded BALI, Kiryat-Ono (IL); Elad Schneor, Tel-Aviv (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: REVOLUTIONARE L.T.D, Tel-Aviv (IL)

(21) Appl. No.: 12/345,750

(22) Filed: Dec. 30, 2008

(51) Int. Cl. G06F 15/16

(52) U.S. Cl. 709/206

(57) ABSTRACT

The subject matter discloses a content server for managing advanced content related to computerized messages, comprising a processing module adapted for associating the advanced content to with a computerized message, wherein the content server resides within an open network. In some cases, the content server is connected to a first communication device used for sending the computerized message and a second communication device used for receiving the computerized message.

The subject matter also discloses a system for automatically adding an advanced content to computerized messages sent over a communication network, the system comprising at least one communication server configured for transferring computerized messages from senders to respective recipients over said communication network, at least one content server connected to said at least one communication server through said communication network, the at least one content server comprising a database of advanced content units and a processing module configured for associating an advanced content unit selected from said database of advanced content units with a computerized message and a content adding module configured for receiving a computerized message and for adding a selected advanced content unit to said computerized message before the computerized message is being sent to a respective recipient, said content adding module residing in either said at least one communication server or in said at least content server.

### BACKGROUND OF THE INVENTION

1. Field of the Invention

The present invention relates to computerized messages in general, and to adding advanced content to computerized messages in particular.

2. Discussion of the Related Art

Computerized messages, such as email messages, have become a highly popular and efficient means to send messages, either via web-based email services such as Gmail, or via mail applications installed on a personal computer such as Microsoft Outlook, instant messaging applications or SMS applications. Many users of such applications and services have a textual signature, mainly comprising name, contact details, and sometimes a short message. It is desired to provide such users with advanced content to be added to their email messages, instead of the textual signature.

The term adding advanced content may refer to any method of formatting the computerized message, or to adding content, for example logo, image, text. It may also relate to the shape and location of the image or logo in the computerized messages the size of each line or column in the computerized message, an attachment automatically added to the computerized message, such as a media file, audio file, video file and the like. Such advanced content may be sender-based, recipient-based, and the like. The advanced content may be added only in case a message is sent outside an organization, according to an IF address or URL related to the recipient.

FIG. 1A shows a computerized environment in which content is added to email messages, according to some embodiments of the prior art. Sender 1 (110), sender 2 (112) and sender N (114) send email messages from an email server 130 stored in an organization or connected to their computers. Such email messages are sent via network 150 to recipient 170. According to the prior art, content server 140 that adds advanced content to the email messages resides within the email server 130 and adds content only to email messages transmitted via the email server 130. In other prior art configurations, the content server 140 resides outside the email server 130 but within the LAN associated with the email server 130 or within the LAN of a specific organization. According to prior art scenario, the email server 130 sends the email message to the content server 140 residing within the email server 130, or contained as an application within the computer that sends the email message. The content server determines the advanced content and adds it to the email message. Next, the email message is sent back to the email server 130 containing the advanced content, and sent from the email server 130 as desired by the sender.

Content servers are frequently installed on a communication server from which the computerized messages are transmitted in a business-oriented version, or installed on a personal computer, laptop, PDA, wireless device or any other personal device used to transmit messages. In such architecture, the addition of content to the email message is limited to the geographic location of the sender. For example, in case some of the senders send messages related to an organization not from the email server of the organization, for example using remote applications, the content will not be added properly since the email message is not transmitted via the email server connected to the content server. Further, such a content server that resides in the communication server or in the LAN associated with a specific organization can only be connected to one communication server and thereby increases costs of content server operators. Additionally, in such architectures, the organization cannot control the properties of the content added to the email messages and IT support is required.

Private users, who wish to add advanced content to their email messages, find that installation of such application is highly uncomfortable and not cost-effective.

In view of the above, a new architecture and method for adding advanced content is desired.

### SUMMARY OF THE PRESENT INVENTION

It is an object of the subject matter to disclose a content server for managing advanced content related to computerized messages, comprising a processing module adapted for associating the advanced content to with a computerized message; wherein the content server resides within an open network.

In some embodiments, the content server further comprises content server is connected to a first communication device used for sending the computerized message and a second communication device used for receiving the computerized message.

In some embodiments, the content server further comprises an I/O device for receiving the computerized messages or metadata relating to computerized message.

In some embodiments, the content server further comprises storage for storing the advanced content.

In some embodiments, the storage further comprises preferences related to senders of the computerized messages.

In some embodiments, the content server sends the computerized messages to the second communication device.

In some embodiments, the content further comprises a user interface for enabling a user to edit advanced content to be added to email messages.

In some embodiments, the content server is capable of being connected to two or more communication servers.

In some embodiments, the content server adds the advanced content according to preferences received from the two or more communication servers.

It is another object of the subject matter to disclose a method of adding advanced content to a computerized message, comprising:

receiving the computerized message or metadata related to the computerized message; determining the advanced content to be added to the computerized message; and adding the determined advanced content to the computerized message; wherein determining the advanced content is performed using an application residing on an open network.

In some embodiments, the method further comprises a step of identifying the computerized message.

In some embodiments, the method further comprises a step of sending the computerized message with the advanced content to a recipient of the computerized message.

In some embodiments, the computerized message is selected from a group consisting of an SMS message, MMS, email message, a message sent via an instant message application or any combination thereof.

In some embodiments, the method further comprises a step of updating a communication metadata related to senders or recipients of the computerized messages.

In some embodiments, identifying the computerized message is performed by receiving a first metadata related to senders or recipients of the computerized messages from a communication server and comparing the first metadata related to senders or recipients with a second metadata related to the computerized message.

In some embodiments, the method further comprises a step of enabling a user to edit the advanced content to be added to the email message. In some embodiments, the method further comprises a step of enabling a user to purchase the advanced content to be added to the email message.

It is another object of the subject matter to disclose a system for automatically adding an advanced content to computerized messages sent over a communication network, the system comprising:

at least one communication server configured for transferring computerized messages from senders to respective recipients over said communication network;

at least one content server connected to said at least one communication server through said communication network, the at least one content server comprising a database of advanced content units and a processing module configured for associating an advanced content unit selected from said database of advanced content units with a computerized message; and

a content adding module configured for receiving a computerized message and for adding a selected advanced content unit to said computerized message before the computerized message is being sent to a respective recipient said content adding module residing in either said at least one communication server or in said at least content server.

### BRIEF DESCRIPTION OF THE DRAWINGS

Exemplary non-limited embodiments of the disclosed subject matter will be described, with reference to the following description of the embodiments in conjunction with the figures. The figures are generally not shown to scale and any sizes are only meant to be exemplary and not necessarily limiting. Corresponding or like elements are designated by the same numerals or letters.

FIG. 1A shows a computerized environment in which content is added to an email message, according to some embodiments of the prior art;

FIG. 1B shows a computerized environment in which content is added to an email message, according to some embodiments of the disclosed subject matter;

FIG. 2 shows a computerized module for handling content to be added to a computerized message, according to some embodiments of the disclosed subject matter; and,

FIG. 3 shows a flowchart of the method for handling content to be added to a computerized message, according to some exemplary embodiments of the disclosed subject matter.

### DETAILED DESCRIPTION OF THE PREFERRED EMBODIMENT

One technical problem addressed by the disclosed subject matter is to add content to email messages sent via a variety of email servers or via web-based email services. Another technical problem is to provide one content server to more than one communication server, and to allow private users and organizations to use the same content server. Further, modifying the specification of a content application on a known content server requires authorizations or IT services. Another technical problem is to provide different users with different content services, without the need to install and update such content server within the user's device or within the user's email server.

The technical solution disclosed in the subject matter is a web-based content server residing on the internet or between a communication server and a web server. Such content server may be connected to email accounts, via one or more communication servers such as email servers, instant messaging applications or web-based email services. The content server of the subject matter may store the preferences of each user or group of users, and determine the advanced content to be added to sent computerized messages automatically. Hence, when a user of a specific organization sends a computerized message from a remote computer or from a wireless device, the computerized message is sent from the remote computer via the internet to the content server, where the advanced content to be added is determined and the computerized message with the added advanced content is then sent to the recipient. One technical effect of the disclosed subject matter is to enable a computerized message to be sent without being transmitted via the organization's email server and still be added with the advanced content and enable checking the user's preferences.

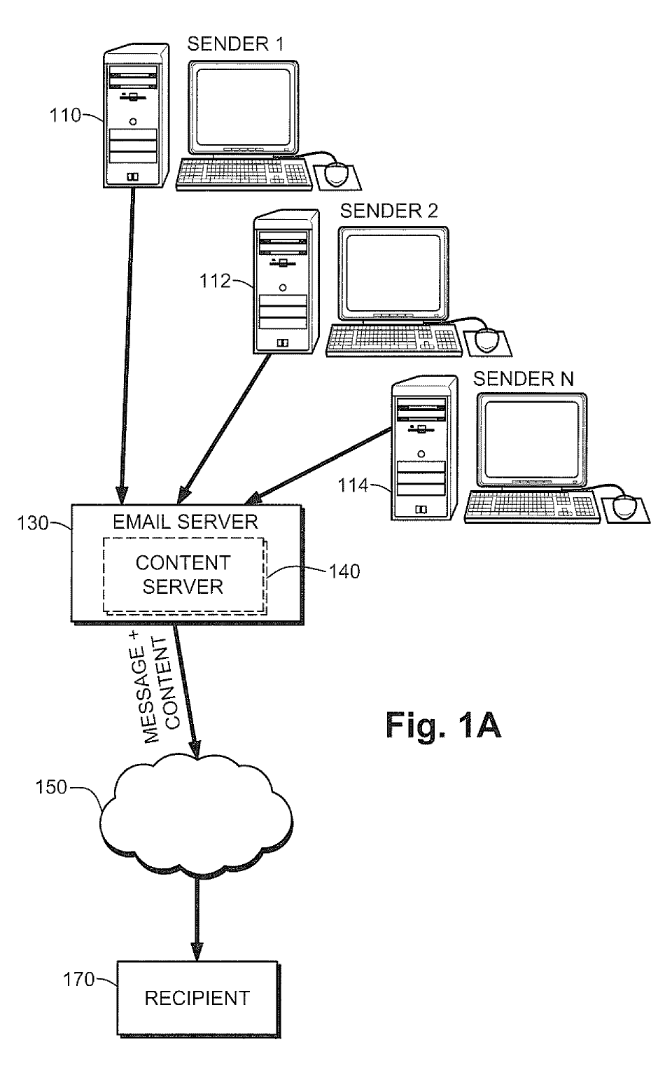

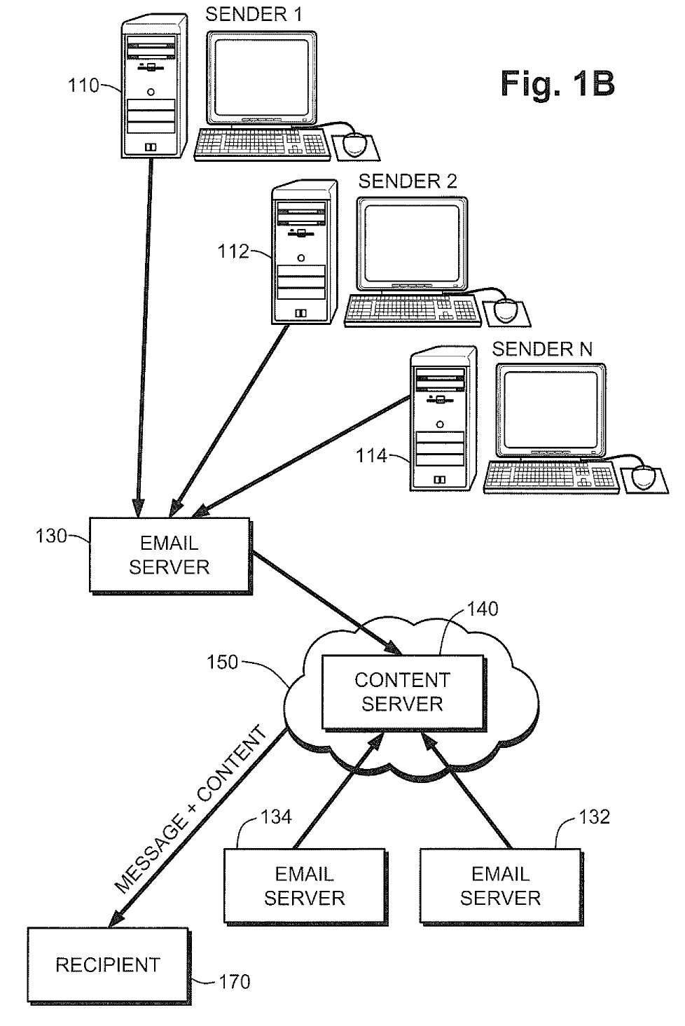

FIG. 1B shows a computerized environment in which content is added to an email message, according to some embodiments of the subject matter. It will be appreciated that the present invention is not limited to email messages and that the following description of the communication servers as email servers and the computerized messages as email messages is provided for simplicity and does not limit the subject matter to the examples belong. According to the figure, an email message is sent from Sender 1 (110), sender 2 (112) or sender N (114) to email server 130 that resides in an organization or is connected to the senders computer, for example a web-based email server. The email message is detected at the email server 130 to determine whether the sender is subscribed at content server 140. In case the sender is subscribed, advanced content is added to the email message according to preferences stored in the content server 140. In one exemplary embodiment, the email message is sent to the content server 140, where content is added and the content server sends the email message to recipient 170 via network 150. Alternatively, the email message containing the advanced content is sent back to the email server 130 that sends the email message to the recipient 170 via the network 150. In another alternative embodiment, the advanced content or a symbol representing the advanced content is sent from the content server 140 to the email server 130, where the advanced content is added to the email message so that the email message containing the advanced content is sent from the email server 130 to the recipient 170.

As a result of residing on an open network, such as the internet, content server 140 may be connected to a plurality of email servers, such as email servers 130, 132 and 134. Each of the email servers 130, 132 and 134 may be either an internal email server residing in a computerized environment within all organization or a web-based email server. Hence, one content server such as the content server 140 may provide advanced content to users of multiple organizations or multiple email servers. In such case, the content server 140 may store advanced content that relates to multiple users of multiple email servers, and adds the advanced content to the email messages accordingly.

In accordance with some exemplary embodiments of the subject matter, the email servers identify the content server 140 according to specifications stored in the email servers. For example, when subscribing to the content server, the users input their email address, as well as specifications such as billing details and the like. The content server sends notifications to the email server associated with the user or to an IT department of an organization with which the user is associated. Hence, when an email message is sent from the email account of a user of the content server 140, the email server such as the email server 130 sends the email message to content server or sends a request to the content server 140 for advanced content to be added to the email message. In accordance with one exemplary embodiment of the subject matter, the identification of the email is performed using SMTP authentication. Other methods for identifying the email message may be determined by a person skilled in the art.

In accordance with some exemplary embodiment of the disclosed subject matter, the preferred embodiment of the content server of the subject matter adds advanced content to email messages. Similarly, advanced content may be added to any type of computerized messages such as SMS, MMS, message sent via an instant messaging application, and any other type of message sent from one computerized device to another computerized device. In some embodiments of the subject matter, the message is sent from communication servers other than email servers, for example servers adapted to handle SMS messages and other type of messages known to the person skilled in the art.

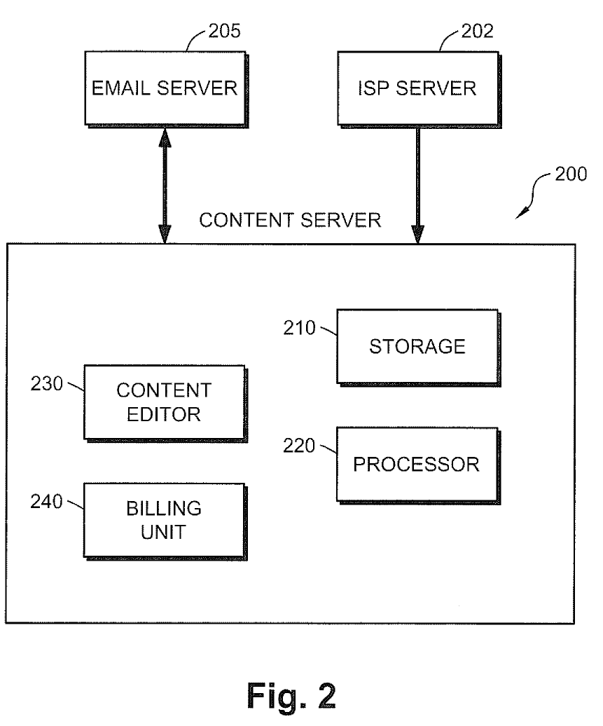

FIG. 2 shows a computerized module for handling advanced content to be added to a computerized message according to some embodiments of the disclosed subject matter. Content server 200 is generally equivalent to content server 140 of FIG. 1B that communicates with one or more communication servers and sends the computerized messages containing the advanced content to either recipient 170 or to the communication server such as email server 130. In accordance with some exemplary embodiments of the subject matter, the content server 200 comprises storage 210 for storing data related to the advanced content. Such data may be the advanced content data related to users of the content server 200, users' preferences, billing terms statistical data related to the number and destinations of email messages sent from a specific user and the like. The storage may use volatile memory or non-volatile memory, such as magnetic disk, flash memories and the like.

Content server 200 may also comprise processor 220 for determining the advanced content to be added to an email message received from an email server. The processor 220 may also determine the method according to which the computerized message is sent to the recipient (170 of FIG. 1B), for example directly from the content server 200 or via the communication server that generated the computerized message. The advanced content may be stored in storage 210 or in another storage communicating with the content sever 200. Determining the advanced content to be added to an email message may be performed as a function of parameters or content within the messages such as the user's preferences, an organization associated with the user, the identity of the sender or of the recipients IP address of the sender or of the recipient, seasonal business messages, coupons, holiday greetings and the like. In some embodiments, processor 220 adds commercial content to the computerized message. Such commercial content may be advertisement not related to the sender of the computerized message, but relates to the recipient or the subject of the message. In accordance with another embodiment of the subject matter the advanced content may be determined randomly from a group of contents selected by the user or a representative of the user of the content server 200. In other embodiments, the sender of the computerized message may choose the advanced content or a symbol representing the selection may be sent to the content server 200. In some exemplary embodiments the processor 220 further comprises an I/O unit (not shown) that receives a request for advanced content with the required details, preferably from a communication server such as email server 205. The processor 220 determines the advanced content to be added to the message and sends the advanced content to the email server 205. In some cases, determining the advanced content refers to converting the selection made by the sender into the corresponding advanced content. Alternatively the I/O unit (not shown) of processor 220 receives an email message the processor 220 retrieves advanced content from an adaptive storage such as storage 210, adds the advanced content to the email message and sends the email message containing the advanced content to the recipient of the email message. The content server 200 may also be connected to a communication server such as an ISP server 202 that stores metadata related to the sender or the recipient of the computerized message.

The content server 200 may also comprise a billing unit 240 that handles billing, issues of the content server 200, stores records concerning the users and the computerized messages sent via the content server 200. Billing a unit 240 may use an I/O unit (not shown) such as a port to send notifications to the users in case the credit of one or more users is lower than a threshold value. The content server 200 may also comprise a content editor 230, for enabling users or their representatives to create advanced content, upload files as advanced content, edit current advanced content, update preferences and the like. Such content editor may comprise an interface (not shown) that enables the user to draw images, record sounds, create text or message specification and create personal advanced content. The content editor 230 may send notifications to other users concerning the personal advanced content and enable trading of such personally created advanced content. The content editor 230 may be connected to a storage device such as storage 210 for storing the personal advanced content and authorize only restricted one or more users to use such personally created advanced content.

The content server 200 may use, handle, add and analyze advanced content using applications that preferably comprise software components written in any programming language such as C, C#, C++. Java, VB, VB.Net, or the like, and developed under any development environment, such as Visual Studio.Net, J2EE or the like. It will be appreciated that the server and the clients can alternatively be implemented as firmware ported for a specific processor such as digital signal processor (DSP) or microcontrollers, or can be implemented as hardware or configurable hardware such as field programmable gate array (FPGA) or application specific integrated circuit (ASIC).

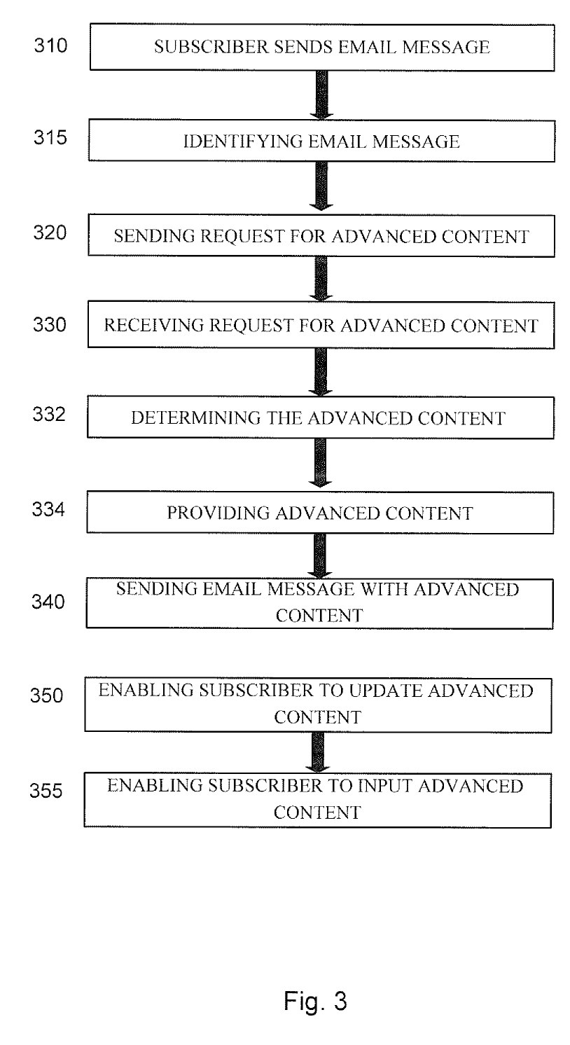

FIG. 3 shows a flowchart of a method for handling advanced content to be added to a computerized message, according to some exemplary embodiments of the subject matter. On step 310, a user of the content server sends the computerized message. The computerized message is received at a communication server and is identified, on step 315, as a computerized message associated with a user of the content server. Such identification may be achieved using data fields within the computerized message, or using data fields within the communication server, such as email addresses, usernames and the like. On step 320, a request is sent from the email server to the content server for receiving advanced content for the computerized message identified on step 315. In some exemplary embodiments, such request may be added to the computerized message, such that both the computerized message and the request are sent to the content server. Alternatively, the request for content server may be sent from an email client, such as a user of Outlook. Thunderbird, Entourage and the like. On step 330, the content server receives the request from the communication server. It is one of the technical effects of the subject matter to retrieve the computerized message, such as the email message, after the computerized message is sent from the communication server, such as the email server. The retrieval may be performed by the content server 200 or by another computerized entity connected to the content server. Hence, the content server may handle messages sent from a plurality of communication servers, and advanced content may be added to messages sent via remote servers or to messages sent via other applications than conventional communication servers, such as email messages sent via mobile phones, email clients and the like.

On step 332, the content server determines the advanced content to be added to the email message according to the request from the email server. Determining the advanced content may be performed using preferences related to the sender, recipient, institute to which the server or recipient belong or relate, IP address, language, country, location, season, date, holiday, weather and the like. On step 334, the content server provides advanced content. Providing the advanced content may be performed by attaching the advanced content to the email message, sending the advanced content to a computerized entity that sends the email message to the recipient, sending a symbol or identity of the advanced content to be added to the email message, and the like. In case only a symbol is added, at least a portion of the advanced content resides on the device that receives the symbol or identity. Such device is capable of converting the symbol or identity into advanced content, and adds the advanced content to the computerized message. On step 340, as an exemplary embodiment of providing the advanced content, the email message containing the added advanced content is sent from the content server to the recipient.

On step 350, the content server enables the user or the representative of the user to update the advanced content to be added to email messages, or the preferences upon which the content server determines the advanced content to be added to email messages sent by the user or group of users. On step 355, the content server enables the user or the representative of the user to input content that is at least a portion of the advanced content to be added. Such content to be added by the user may be media file such as video or audio file created by the user and uploaded to the content server or to another computerized entity connected to the content server.

While the disclosure has been described with reference to exemplary embodiments, it will be understood by those skilled in the art that various chances may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A content server for managing advanced content related to computerized messages, comprising
a processing module adapted for associating the advanced content to with a computerized message;
wherein the content server resides within an open network.

2. The content server according to claim 1, wherein the content server is connected to a first communication device used for sending the computerized message and a second communication device used for receiving the computerized message.

3. The content server according to claim 2, wherein the content server sends the computerized messages to the second communication device.

4. The content server according to claim 1, further comprising an I/O device for receiving the computerized messages or metadata relating to computerized message.

5. The content server according to claim 1, further comprising storage for storing the advanced content.

6. The content server according to claim 1, wherein the storage further comprises preferences related to senders of the computerized messages.

7. The content server according to claim 1, further comprising a user interface for enabling a user to edit advanced content to be added to email messages.

8. The content server according to claim 1, wherein the content server is capable of being connected to two or more communication servers.

9. The content server according to claim 8, wherein the content server adds the advanced content according to preferences received from the two or more communication servers.

10. A method of adding advanced content to a computerized message, comprising:
receiving the computerized message or metadata related to the computerized message;
determining the advanced content to be added to the computerized message; and
adding the determined advanced content to the computerized message;
wherein determining the advanced content is performed using an application residing on an open network.

11. The method according to claim 10, further comprising a step of identifying the computerized message.

12. The method according to claim 11, wherein identifying the computerized message is performed by receiving a first metadata related to senders or recipients of the computerized messages from a communication server and comparing the first metadata related to senders or recipients with a second metadata related to the computerized message.

13. The method according to claim 10, further comprising a step of sending the computerized message with the advanced content to a recipient of the computerized message.

14. The method according to claim 10, Wherein the computerized message is selected from a group consisting of an SMS message. MMS, email message, a message sent via an instant message application or any combination thereof.

15. The method according to claim 10, further comprising a step of updating a communication metadata related to senders or recipients of the computerized messages.

16. The method according to claim 10, further comprising a step of enabling a user to edit the advanced content to be added to the email message.

17. The method according to claim 10, further comprising a step of enabling a user to purchase the advanced content to be added to the email message.

18. A system for automatically adding an advanced content to computerized messages sent over a communication network, the system comprising:
at least one communication server configured for transferring computerized messages from senders to respective recipients over said communication network;
at least one content server connected to said at least one communication server through said communication network, the at least one content server comprising a database of advanced content units and a processing module configured for associating an advanced content unit selected from said database of advanced content units with a computerized message; and
a content adding module configured for receiving a computerized message and for adding a selected advanced content unit to said computerized message before the computerized message is being sent to a respective recipient, said content adding module residing in either said at least one communication server or in said at least content server.
